(19) United States
(12) Patent Application Publication
(10) Pub. No.: US 2024/0303491 A1
(43) Pub. Date: Sep. 12, 2024

(54) EFFICIENT PARALLEL SEARCH FOR PRUNED MODEL IN EDGE ENVIRONMENTS

(71) Applicant: Dell Products L.P., Round Rock, TX (US)

(72) Inventors: Vinicius Michel Gottin, Rio de Janeiro (BR); Paulo Abelha Ferreira, Rio de Janeiro (BR); Pablo Nascimento da Silva, Niterói (BR)

(21) Appl. No.: 18/179,472

(22) Filed: Mar. 7, 2023

(51) Int. Cl. G06N 3/082

(52) U.S. Cl. CPC G06N 3/082

(57) ABSTRACT

Searching for a model is disclosed. Source nodes are configured to generate pruned candidate models starting from a distribution of models. A central node receives the pruned candidate models and their associated loss values. The central mode causes the pruned candidate models to be tested in a distributed manner at generalization nodes. Loss values returned to the central mode are associated with the pruned candidate models. The pruned candidate model with a lowest loss score, based on the distributed generalization testing, is selected as a winning candidate model and deployed to target nodes.

### FIELD OF THE INVENTION

Embodiments of the present invention generally relate to machine learning models. More particularly, at least some embodiments of the invention relate to systems, hardware, software, computer-readable media, and methods for searching for models to deploy to edge nodes in an edge environment.

### BACKGROUND

Many environments and systems benefit from machine learning models. The machine learning models may operate at devices in the environment and perform a variety of operations. Logistics operations, for example, benefit from machine learning models. For example, a device may be equipped with a machine learning model that can predict collisions, dangerous maneuvers, or the like and generate alarms or take preventive actions.

There are challenges to using machine learning models in these environments. For example, each device (or node) in the environment may have local data that should be kept private from other nodes. In addition, the computing resources at many nodes may be inadequate for exhaustive model training. These constraints can complicate the process of deploying models to edge nodes.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1A discloses aspects of an environment in which machine learning models are deployed to edge nodes;

FIG. 1B discloses aspects of deploying models to source nodes for training with distilled datasets;

FIG. 2 discloses aspects of generating pruned candidate models at source nodes in the environment;

FIG. 3 discloses aspects of selecting test candidates from the pruned candidate models, performing generalization operations on the test candidates at generalization nodes, selecting a winning candidate and deploying the winning candidate to target nodes;

FIG. 4 discloses aspects of an assessment structure for centrally storing pruned candidate nodes and associated loss values;

FIG. 5 discloses aspects of generalizing test candidates and/or pruned candidate models based on multiple loss evaluations;

FIG. 6 discloses aspects of relationships between source nodes, a central node, generalization nodes, and target nodes when searching for a model to deploy to the target nodes; and

FIG. 7 discloses aspects of a computing device, system, or entity.

### DETAILED DESCRIPTION OF SOME EXAMPLE EMBODIMENTS

Embodiments of the present invention generally relate to machine learning models. More particularly, at least some embodiments of the invention relate to systems, hardware, software, computer-readable media, and methods for searching for a machine learning model that can be deployed to nodes in an environment.

In general, embodiments of the invention aim to find/generate a model that can achieve sufficient accuracy, generalize to a domain, and/or ensure privacy. The model should be relatively small given potential resource constraints at some of the edge nodes. Embodiments of the invention ensure that a model can be trained and deployed to edge nodes that do not have the resources required for larger models. Often, these models are pruned models that still provide accuracy that is similar to the accuracy of larger models.

Embodiments of the invention relate to searching for a model that can be deployed to nodes in an environment. In one example, a central node may orchestrate or coordinate with edge nodes so that each (or some) node generates an initial candidate model, which is a random initialization of weights for a full model architecture. The initial candidate model may be trained using a distilled dataset and subsequently pruned according to a magnitude criterion or using other techniques. This yields a pruned candidate model that is smaller than the original full model. When performed at multiple nodes, this results in multiple pruned candidate models that can be validated or tested at the node at which they were generated. Testing the pruned candidate models results in a loss value or loss data.

The resulting pruned candidate models and their respective loss values are communicated to the central node. The central node coordinates a validation or generalization operation by distributing the pruned candidate model to other edge nodes, which perform local validation using their locally available data. The loss values generated by these evaluations at other nodes are communicated back to the central node. Pruned candidate models that do not generalize well, as evidenced by their loss values, may be discarded. The best or winning pruned candidate model may be retained and deployed to some of the other nodes in the environment.

Embodiments of the invention relate to an asynchronous and continuous process for obtaining pruned candidate models. This process uses parallelization in the edge nodes with sufficient resources to train/prune models. In some examples, distilled datasets may be used for training efficiencies. In addition, data privacy in a pruned candidate model search in a distributed environment is preserved. Further, the generality of the resulting pruned candidate models is ensured by orchestrating a distributed generalization or validation operation in which the pruned candidate models are tested at other nodes.

In one example, multiple pruned candidate models are generated because many of the pruned candidate models will be discarded. However, the lottery ticket hypothesis generally states that it is possible to find a sparser network or model (e.g., neural network) inside an existing neural network that, when trained, can match the test accuracy of the original more-dense neural network. The lottery ticket method uncovers the sparser neural network by performing at least one round of training, followed by at least one round of pruning. The pruning operations may have a decay function so that there is less pruning as the rounds of training proceed. The sparser network, that meets criteria such as accuracy compared to the full model, may be referred to as the winning ticket or the winning candidate. Even if the sparser model is found in this manner, the sparser model is trained to obtain a well-performing model. The benefit, after training, is that inference can be performed at a lower cost due to the sparsity of the pruned model.

Embodiments of the invention may search for a pruned model using distilled dataset and federated distilled datasets. A federated distilled dataset is described in U.S. Ser. No. 18/157,966 filed Jan. 23, 2023 and entitled ROBUST AGGREGATION FOR FEDERATED DATASET DISTILLATION, which is incorporated by reference in its entirety.

A distilled dataset, in one example, is a smaller dataset, which may be synthetic, that can be used to train a model. Embodiments of the invention may use distilled datasets that is generalized while ensuring coherence, with respect to drift, malicious attacks, or other deviations, from one or more edge nodes. A distilled dataset may be used in a parallel search for, by way of example, a lottery ticket pruned model.

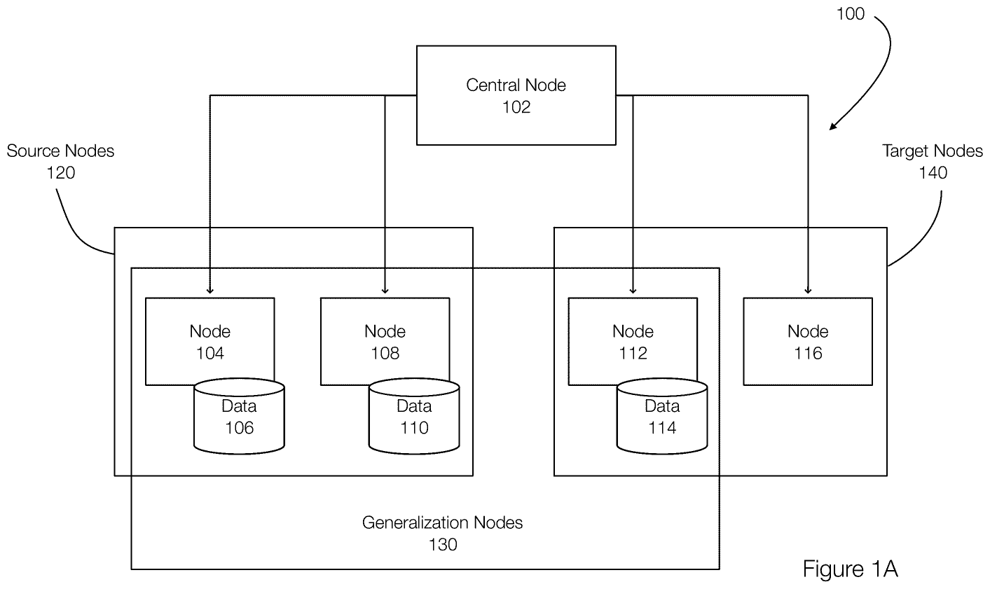

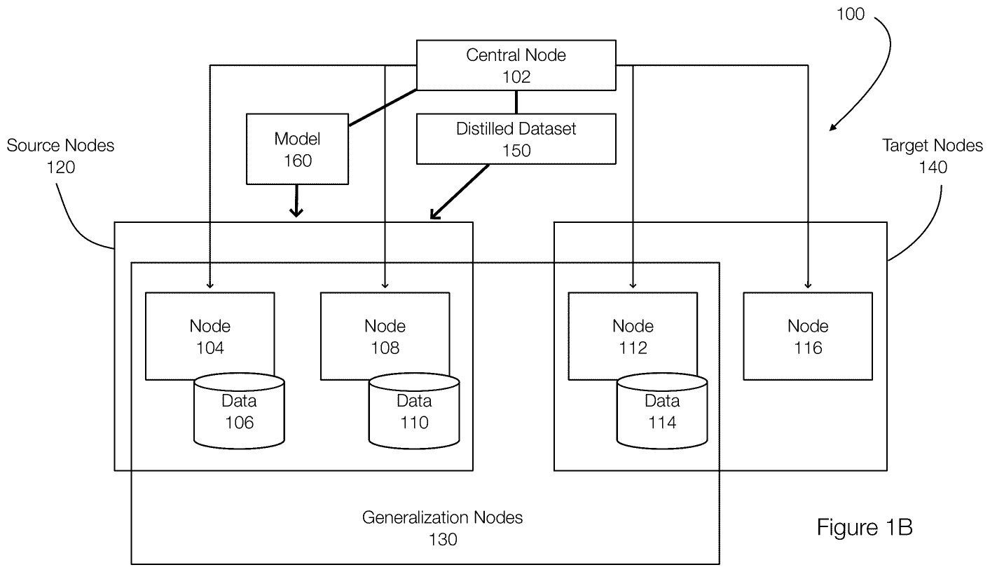

FIG. 1A discloses aspects of an environment in which machine learning models may be, trained, deployed, searched, and operated. FIG. 1A illustrates a central node 102 that is associated with edge nodes represented by nodes 104, 108, 112, and 116. Each of the nodes 104, 108, and 112 116 is associated with, respectively, local data 106, 110, and 114. The node 116 does not have local data at this point (although data may be generated later).

The central node 102 may be located at in an edge system, in the cloud (e.g., datacenter) or the like may include processors, memory, networking hardware, and the like. The nodes 104, 108, 112, and 116 may include similar hardware. Generally, the computing resources of the central node 102 are larger and more comprehensive than the computing resources of the nodes 104, 108, 112, and 116.

The nodes 104, 108, 112, and 116 may represent devices operating in a single environment, in different environments, in different but related environments, in distributed environments, or the like. Models can be searched while keeping the respective data of each of the nodes 104, 108, 112, and 116 private. For example, the data 106 is not shared with any of the other nodes 108, 112, and 116 and may not be shared with the central node 102 in some embodiments.

In this example, the nodes 104, 108, 112, and 116 (nodes generally represented as [symbol] ) may have heterogeneous computing capabilities. In this example, the node 112 (Eⱼ) is a node with restricted computational resources compared to the nodes 104 and 108. The node 116 (Eₖ) is a node without a local dataset and/or restricted computational resources. Neither of the nodes 112 and 116 are capable of training a local machine learning model and are referred to as target nodes 140 ( [symbol] _{T}), wherein ( [symbol] _{T} ⊂ [symbol] ).

Embodiments of the invention search or a model (e.g., a winning ticket model) that is trained by another edge node and validated by multiple other edge nodes that can be deployed to the target nodes 140. In this example, the model is trained at other nodes using the local data of those nodes. However, the data is not communicated to the target nodes 140.

FIG. 1A also illustrates source nodes ( [symbol] _{S}) 120 where ( [symbol] _{S} ⊂ [symbol] ). The source nodes 120 have both the computational resources and local datasets and are capable of training a model. The source nodes 120 are nodes that originate or generate new pruned candidate models and the models deployed to the target nodes 140 are selected from the pruned candidate models generated at the source nodes 120.

FIG. 1A also illustrates generalization nodes ( [symbol] _{G}) 130, where ( [symbol] _{G} ⊂ [symbol] ). The generalization nodes 130 includes nodes with local datasets and with sufficient computational resources to perform at least a single evaluation of a pruned candidate model using the local dataset and/or a distilled dataset. In this example, the source nodes 120 are included in the generalization nodes 130 ( [symbol] _{S} ⊂ [symbol] _{G}) as illustrated in FIG. 1A. The generalization nodes 130 examples of nodes that may be used for distributed generalization validation of the pruned model candidates. In other words, the generalization of pruned candidate models can be validated or verified by testing the pruned candidate models at other generalization nodes 130.

FIG. 1B discloses aspects of a distilled dataset. Embodiments of the invention may include a distilled dataset (D_{dist}) 150 that may have been previously generated as described in ROBUST AGGREGATION FOR FEDERATED DATASET DISTILLATION. The distilled dataset 150 may have been obtained locally or generated in a distributed fashion.

In this example, the distilled dataset 150 is distributed to the source nodes 120 (or portion of the source nodes). In addition to the distilled dataset 150, a model 160 may be distributed to the source nodes 120. More specifically in one example, a model's weights θ, a distribution function p(·), the learning rate \tilde{η}, and number of epochs ∈ determined in the distillation process may be distributed to the source nodes 120 These are relative small, compared to a full model or traditional machine learning dataset, and communicating these values may not significantly add to the overhead of the edge environment. Further, if the source nodes 120 are the same nodes used for a federated distillation process, the parameters are already known by the edge nodes and the communication of these parameters may not be required.

The nodes 104, 108, 112, and 116 in the environment 100 are shown by way of example and represent multiple nodes. Embodiments of the invention are able to search for a model to deploy to, for example, the target nodes 140 using multiple source nodes 120 in parallel while ensuring data privacy as each of the source nodes 120 participating in the search uses its local data for validation of the candidate pruned models without sharing data.

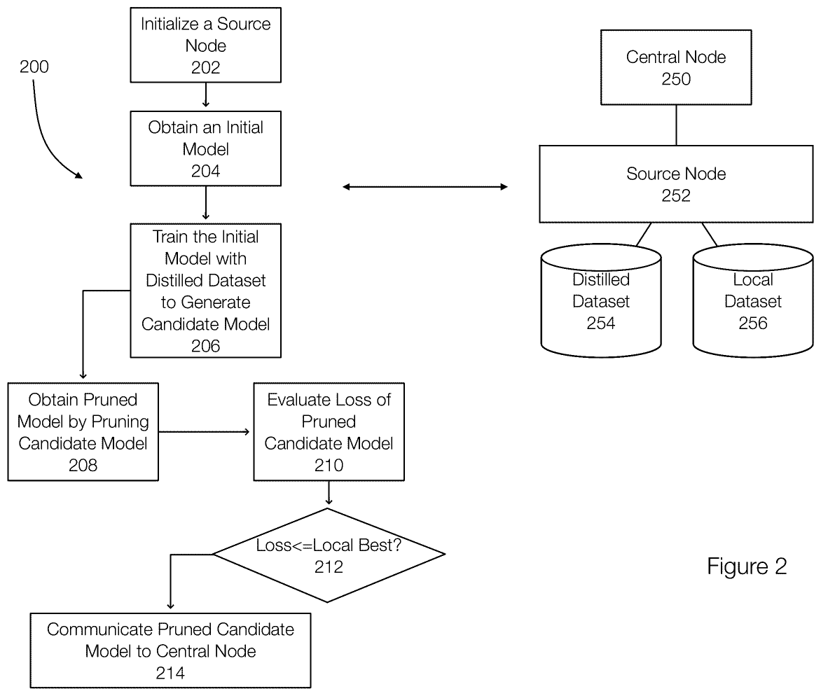

Searching for a pruned candidate model is a process that may include participation from various types of nodes including source nodes (Eᵢ), the central node (A), a generalization node (Eⱼ), and a target node (Eₖ). FIG. 2 discloses aspects of searching for a model.

FIG. 2 illustrates a method in the context of a source node 252. In the method 200, a source node is initialized 202 with parameters including the parameters for the initial model (θ), the number of epochs for training (∈) and a learning rate (η) forthe training operations. Once a source node is initialized, an initial model is obtained 204. The initial model may be obtained by the source node sampling a distribution p(θ) to obtain an initial model configuration θ₀ⁱ. This is the equivalent of sampling the model parameters for the dataset distillation process such that the initial model θ₀ⁱ is one from the family of models defined by p(θ).

Next, the source node trains 206 the initial model with the distilled dataset 254 (D_{dist}) to generate a candidate model θ_{∈}ⁱ. Because the initial model is trained with the distilled dataset 254, the training is efficient and fast and can be performed at resource constrained nodes. The trained candidate model θ_{∈}ⁱ is then pruned 208 to yield a pruned candidate model θ_{f}ⁱ. In one example, pruning may be performed by pruning weights based on a magnitude threshold operation. The weights may be pruned as follows:

$$\{ \begin{matrix}0 , & if \vert {θ}_{{f}_{h}}^{i} \vert \leq th \\ {θ}_{{f}_{h}}^{i} , & if \vert {θ}_{{f}_{h}}^{i} \vert > th\end{matrix}$$

In one example, the training and pruning operations may be repeated. This process results in a pruned version θ_{f}ⁱ of the model. This process may be performed for multiple initial models (different samples from p(θ)) to ultimately generate multiple pruned candidate models. Many of the trained and pruned models may suffer significant degradation. According to the lottery ticket hypothesis, only a few of the pruned candidate models have a level of accuracy similar to that of the full models.

Embodiments of the invention thus evaluate multiple pruned candidate models to determine whether one of the pruned candidate models has sufficient performance or accuracy. Thus, for each of the pruned candidate models, a loss evaluation is performed 210. The loss evaluation (e.g., validation) is performed using the local dataset (Dᵢ) 256. The loss evaluation may be:

Lᵢ=l(Dᵢ,θ_{f}ⁱ)

In one example, the validation may be performed for fixed-sized batches of data (d ⊂Dᵢ) to obtain a loss distribution. An aggregate measure, such as an average, for the loss of the candidate pruned model θ_{f}ⁱ can be obtained over the whole of the local dataset 256 (Dᵢ). Other aggregations may be performed.

The losses of the various candidate pruned models can be stored in a dataset ( [symbol] ᵢ). If a current pruned candidate model has a loss that significantly worse than the loss of previously evaluated pruned candidate models, the current pruned candidate model can be discarded. For example, if the loss Lᵢ of the current pruned candidate model is below the mean minus two standard deviations, the pruned candidate is discarded. This is represented as:

$$Store {L}_{i} in local storage {𝕃}_{i}$$

$$if {L}_{i} \geq μ ( {𝕃}_{i} ) - 2 σ ( {𝕃}_{i} ) ; discard {θ}_{f}^{i}$$

Over time, the dataset [symbol] ᵢ, can be used to filter pruned candidate modes that are not among the best pruned candidate models. Thus, the dataset [symbol] ᵢ may include aggregate statistics, such as the mean and standard deviation, of loss evaluations for previous pruned candidate models.

After the pruned candidate model θ_{f}ⁱ is evaluated locally against the local dataset and deemed adequate, the pruned candidate model may be communicated 214 to the central node. The communication to the central node 250 may include the pruned candidate model parameters and the loss.

In one example, the model architecture is known to the central node 250. As a result, it may be sufficient to communicate the model's weights, with the pruned weights set to zero. Quantization and/or compression schemes may be used to reduce communication costs.

A random seed used to generate the initial model θ₀ⁱ (the model prior to training and pruning) may be able to uniquely identify the pruned candidate model. The aggregate loss Lᵢ obtained from the pruned candidate model θ_{f}ⁱ over the local dataset 256 (Dᵢ) may be communicated to the central node 250. The aggregate loss, as previous stated, may be the mean loss obtained over all samples in the local dataset 256.

In one example, the source node 252 may communicate multiple pruned candidate models to the central node 250. The pruned candidate models may be distinguished by the random seed. For example, the source node 252 may communicate the following pruned candidate models to the central 250, which are distinguished by the random seeds s and q.

[symbol]

θ_{f}ⁱ|s [symbol] ,L and [symbol] θ_{f}ⁱ|q [symbol] ,L

If the source node 252 only communicates the loss and the random seed, the central node 250 may be required to replicate the training process to obtain the pruned candidate models. This can be performed because the central node 250 has all the information required, including the distilled dataset 254 and the training parameterizations. In this example, the central node 250 may have processing overhead, but communication costs are substantially reduced.

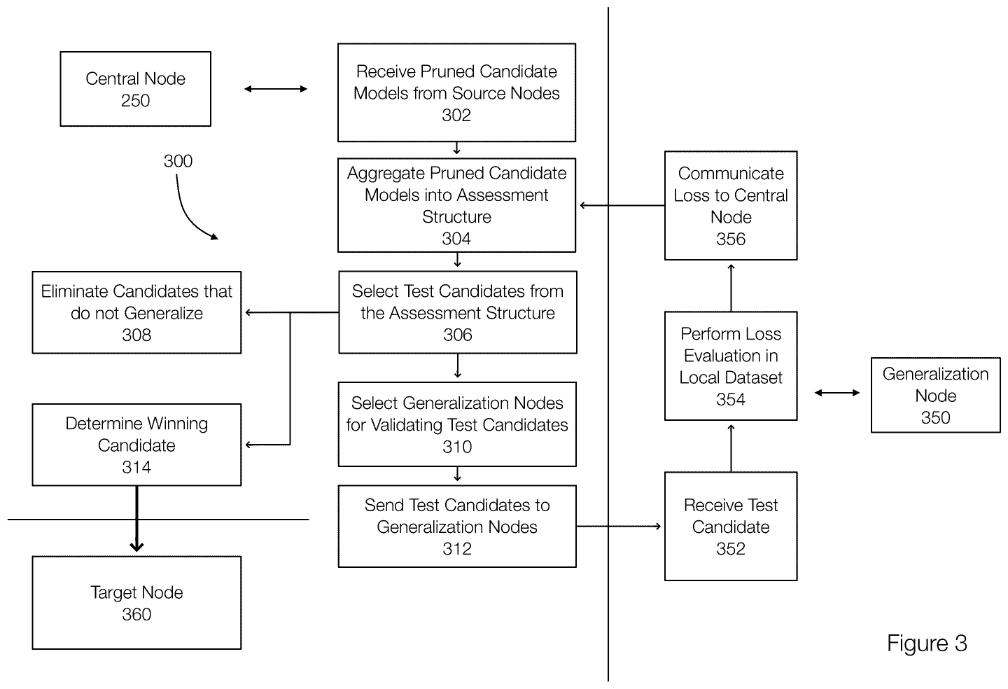

FIG. 3 discloses subsequent aspects of searching for a pruned candidate model in the context of a central node and a generalization node after receiving the pruned candidate models from the source nodes. In FIG. 3, the central node 250 may receive 302 pruned candidate models from multiple source nodes. The candidate pruned models may be stored or aggregated 304 into an assessment structure (T). The assessment structure may store the pruned candidate models and their validation losses.

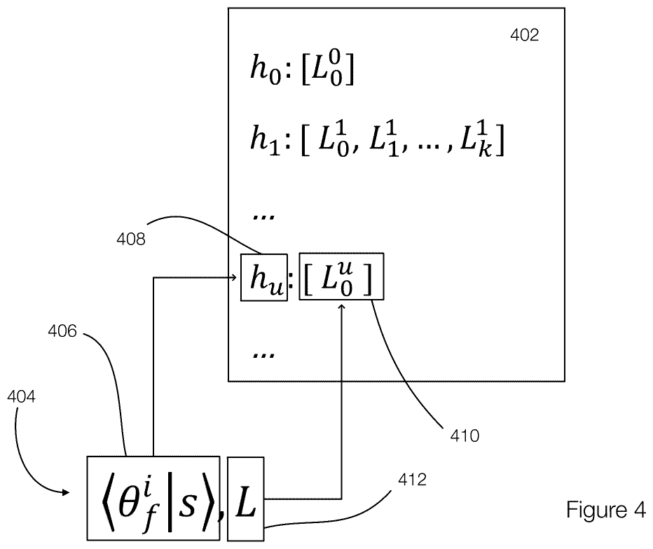

FIG. 4 discloses aspects of an assessment structure. FIG. 4 illustrates an assessment structure 402 configured to store the communications (the pruned candidate models and loss values) from the source nodes. An example communication 404 may include a pruned candidate model 406 and an associated loss 412. The pruned candidate model 406 is entered into the assessment structure 402 with an identifying name 408 and an associated loss 410. The identifying name 408 (e.g., hᵤ), by way of example, may be a combination of the random seed, which was used to generate the original candidate before training and pruning, and an identification of the source node at which the pruned candidate model was trained. Thus, the assessment structure 402 will link or relate each pruned candidate model h to a list of loss values as illustrated in FIG. 4.

In another example, the pruned candidate model may be given an identifier using a predetermined hashing function applied to the model's structure or weights. If two source nodes generate pruned candidate models that are similar, hashing the weights would indicate that these pruned candidate models are substantially the same.

The assessment structure 402 illustrates that some of the pruned candidate models are associated with multiple loss values. The loss values added to the lists in the assessment structure may be generated during distributed testing (e.g., validation or generalization) operations, which is performed at the generalization nodes.

Returning to FIG. 3, after the pruned candidates are aggregated 304 or ingested into the assessment structure, test candidates are selected 306 from the assessment structure by the central node. In one example, all of the pruned candidate models are test candidates. However, some of the pruned candidate models may be selected as test candidates before others. Alternatively, the pruned candidate models may be tested in a particular order that depends on various factors, such as current loss value, number of loss values in the associated list, or the like. The process of selecting test candidates may be an ongoing or continuous operation or may be triggered when the assessment structure is updated. Each of the test candidates thus corresponds to a pruned candidate model.

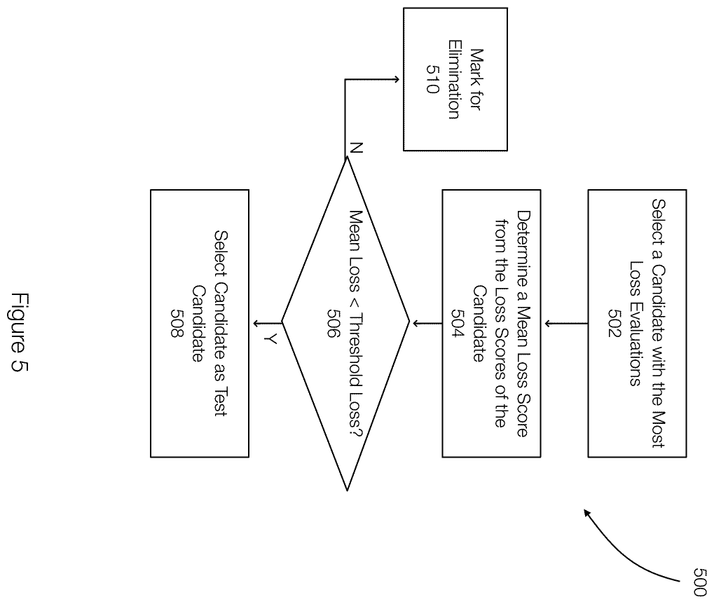

FIG. 5 discloses aspects of selecting test candidates from the assessment structure. In the method 500, a pruned candidate model (e.g., model h) with the most loss evaluations is selected 502. The mean loss L Is determined 504 from the loss values or losses associated with the selected pruned candidate model. If the mean loss is less than a threshold loss (L̅<L_{threshold}) (Y at 506), the pruned candidate model is selected 508 as a test candidate. Otherwise (N at 506), the pruned candidate model is marked 510 for elimination.

When a model is marked for elimination, this suggests that the pruned candidate model does not generalize across the nodes and is eliminated 308. More specifically, when the mean loss value is higher than a threshold loss value, this suggests that the test candidate is not generalizing well or is too degraded compared to the full model. As a result, the pruned candidate model may be deleted.

Returning to FIG. 3, the central node selects 310 generalization nodes for testing operations. The pruned candidate models selected as test candidates are sent 312 to the generalization nodes. In one example, a test candidate may be sent to one or more generalization nodes. Multiple test candidates may each be sent to one or more generalization nodes for testing or, more specifically, for loss evaluation purposes.

FIG. 3 also illustrates aspects of generalization or validation operations performed on generalization nodes, such as the generalization node 350. As previously stated and as illustrated in FIG. 1, the source nodes 120 may also be generalization nodes 130.

One purpose of testing a test candidate on multiple generalization nodes is to determine whether the test candidate, which was each trained on a specific source node and validated against a local data set of that source node, can also perform adequately on a different node that is associated with different local data. However, source nodes that are generating and training new pruned candidate models are not available for additional loss evaluations.

In this example, the generalization node 350 receives 352 a test candidate (e.g., one of the pruned candidate models in the assessment structure) from the central node 250. A loss evaluation is performed 354 at the generalization node 350 using a local dataset of the generalization node 350. The resulting loss value is communicated 356 back to the central node 250 and incorporated into the assessment structure. As previously stated, the loss values generated at the generalization nodes are added to the lists of pertinent loss values.

This process can be repeated such that the test candidates are distributed and evaluated at multiple generalization nodes. This allows the ability of a particular test candidate to demonstrate that it can generalized to multiple different datasets and suggests that the model may be suitable for deployment.

When a test candidate is determined to be sufficiently generalized and sufficient accurate, the test candidate become a winning candidate and may be deployed to a target node 360. More generally, the winning candidate may be the test candidate with a lowest average lost value. The winning candidate may change as additional loss evaluations are received. Thus, the current winning model may be discarded if another pruned candidate model achieves a better score (e.g., lower loss value) during a next verification process.

Embodiments of the invention allow a target node to receive a trained pruned model that is comparatively small (it has been pruned) and accurate based on the distributed validation/generalization operations that include evaluating test candidates at multiple generalization nodes.

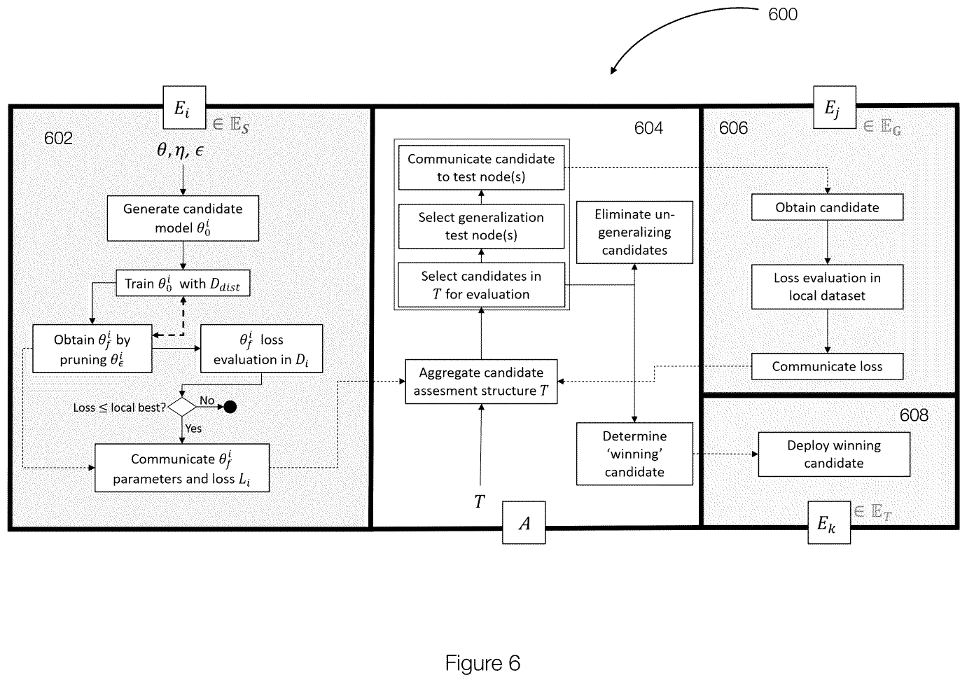

FIG. 6 discloses aspects of searching for a pruned model in an edge environment that can be deployed to nodes in the edge environment. FIG. 6 illustrates relationships among nodes while searching for a model that can be deployed to target nodes. The nodes 600 include a source node 602 (Eᵢ), a generalized node 606 (Eⱼ), a target node 608 (Eₖ), and a central node (A). FIG. 6 also illustrates which node types (e.g., source, generalized, target) perform various aspects of embodiments of the invention described in FIGS. 2-5. Some of the source nodes 602, in general, are configured to generate pruned candidate models. The central node 604 receives pruned candidate models and is configured to distribute the pruned candidate models as test candidates to the generalization nodes 606. The loss values associated with the loss evaluations performed at the generalization nodes 606, plus the loss value generated at the source node, allows the central node 604 to eliminate test candidates from further consideration. The loss values also allow the central model to select a winning candidate from among the test candidates. The winning candidate model is small, compared to a full model, has an accuracy that is sufficient and comparable to an accuracy of the full model, and has demonstrated that it generalizes well as evidenced by the loss evaluations received from multiple generalization nodes. The winning candidate can be deployed to the target nodes 608.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, machine learning operations, model initialization operations, model training operations, model pruning operations, model testing operations, loss evaluation operations, generalization operations, validation operations, or the like or combinations thereof. More generally, the scope of the invention embraces any operating environment in which the disclosed concepts may be useful.

New and/or modified data collected and/or generated in connection with some embodiments, which may include models, weights, distilled datasets, or the like, may be stored in a computing environment that may take the form of a public or private cloud storage environment, an on-premises storage environment, and hybrid storage environments that include public and private elements. Any of these example storage environments, may be partly, or completely, virtualized.

Example cloud computing environments, which may or may not be public, include storage environments that may provide data protection functionality for one or more clients. Another example of a cloud computing environment is one in which processing, inference, and other services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data, models, or the like. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, storage system components such as databases, storage servers, storage volumes (LUNs), storage disks, for example, may likewise take the form of software, physical machines, containers, or virtual machines (VMs), though no particular component implementation is required for any embodiment.

As used herein, the term ‘data’ is intended to be broad in scope. Thus, that term embraces, by way of example and not limitation, distilled datasets, training datasets, model parameters, model weights, candidate models, machine learning models, or the like. Example embodiments of the invention are applicable to any system capable of storing and handling various types of objects, in analog, digital, or other form.

It is noted with respect to the disclosed methods including the Figures, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method comprising: receiving pruned candidate models and associated loss values from source nodes in a distributed computing environment, wherein the pruned candidate models are stored in an assessment structure, selecting test candidates from the pruned candidate models, testing the test candidates at generalization nodes in the distributed computing environment, receiving loss values for the test candidates from the generalization nodes, selecting a winning candidate from the test candidates based on aggregated loss values of the test candidates, and deploying the winning candidate to one or more target nodes.

Embodiment 2. The method of embodiment 1, further comprising initializing the source nodes with parameters of initial candidate models, a number of epochs of training, and a learning rate.

Embodiment 3. The method of embodiment 1 and/or 2, further comprising, at each source node, generating an initial model and training the initial model with a distilled dataset to generate a candidate model and pruning the candidate model to generate a pruned candidate model.

Embodiment 4. The method of embodiment 1, 2, and/or 3, further comprising retraining and repruning the pruned candidate model one or more times.

Embodiment 5. The method of embodiment 1, 2, 3, and/or 4, further comprising communicating the pruned candidate model to the central node along with a loss value based on a local dataset of the source node.

Embodiment 6. The method of embodiment 1, 2, 3, 4, and/or 5, further comprising storing the pruned candidate models and their loss values in the assessment structure and adding loss values determined by the generalization nodes to the loss values in the assessment structure.

Embodiment 7. The method of embodiment 1, 2, 3, 4, 5, and/or 6, further comprising determining an aggregated loss for each of the test candidates identified in the assessment structure.

Embodiment 8. The method of embodiment 1, 2, 3, 4, 5, 6, and/or 7, further comprising eliminating test candidates whose aggregated loss is greater than a threshold loss.

Embodiment 9. The method of embodiment 1, 2, 3, 4, 5, 6, 7, and/or 8, further comprising determining the winning candidate as the test candidate with a lowest aggregated loss.

Embodiment 10. The method of embodiment 1, 2, 3, 4, 5, 6, 7, 8, and/or 9, wherein the pruned candidate models are generated in a parallel manner at multiple source nodes and wherein the test candidates are tested in a parallel manner at multiple generalization nodes.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term client, module, component, agent, engine, service, or the like may refer to software objects or routines that execute on a computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

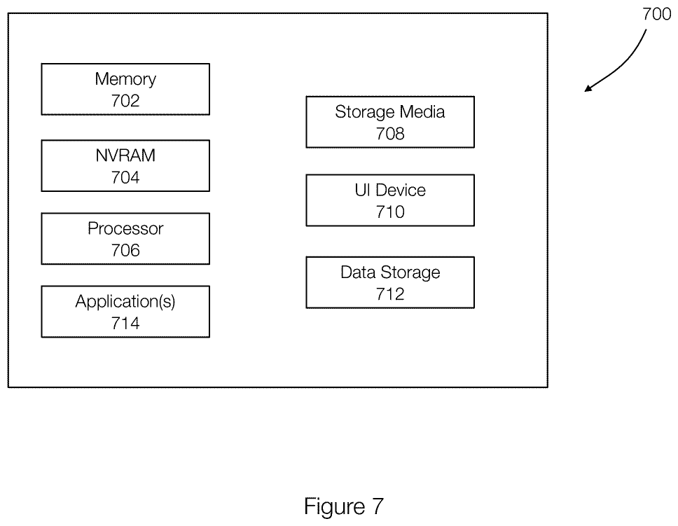

With reference briefly now to FIG. 7, any one or more of the entities disclosed, or implied, by the Figures and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 701 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving pruned candidate models and associated loss values from source nodes in a distributed computing environment, wherein the pruned candidate models are stored in an assessment structure;
selecting test candidates from the pruned candidate models;
testing the test candidates at generalization nodes in the distributed computing environment;
receiving loss values for the test candidates from the generalization nodes;
selecting a winning candidate from the test candidates based on aggregated loss values of the test candidates; and
deploying the winning candidate to one or more target nodes.

2. The method of claim 1, further comprising initializing the source nodes with parameters of initial candidate models, a number of epochs of training, and a learning rate.

3. The method of claim 2, further comprising, at each source node, generating an initial model and training the initial model with a distilled dataset to generate a candidate model and pruning the candidate model to generate a pruned candidate model.

4. The method of claim 3, further comprising retraining and repruning the pruned candidate model one or more times.

5. The method of claim 3, further comprising communicating the pruned candidate model to the central node along with a loss value based on a local dataset of the source node.

6. The method of claim 1, further comprising storing the pruned candidate models and their loss values in the assessment structure and adding loss values determined by the generalization nodes to the loss values in the assessment structure.

7. The method of claim 1, further comprising determining an aggregated loss for each of the test candidates identified in the assessment structure.

8. The method of claim 7, further comprising eliminating test candidates whose aggregated loss is greater than a threshold loss.

9. The method of claim 7, further comprising determining the winning candidate as the test candidate with a lowest aggregated loss.

10. The method of claim 1, wherein the pruned candidate models are generated in a parallel manner at multiple source nodes and wherein the test candidates are tested in a parallel manner at multiple generalization nodes.

11. A non-transitory storage medium having stored therein instructions that are executable by one or more hardware processors to perform operations comprising:
receiving pruned candidate models and associated loss values from source nodes in a distributed computing environment, wherein the pruned candidate models are stored in an assessment structure;
selecting test candidates from the pruned candidate models;
testing the test candidates at generalization nodes in the distributed computing environment;
receiving loss values for the test candidates from the generalization nodes;
selecting a winning candidate from the test candidates based on aggregated loss values of the test candidates; and
deploying the winning candidate to one or more target nodes.

12. The non-transitory storage medium of claim 11, further comprising initializing the source nodes with parameters of initial candidate models, a number of epochs of training, and a learning rate.

13. The non-transitory storage medium of claim 12, further comprising, at each source node, generating an initial model and training the initial model with a distilled dataset to generate a candidate model and pruning the candidate model to generate a pruned candidate model.

14. The non-transitory storage medium of claim 13, further comprising retraining and repruning the pruned candidate model one or more times.

15. The non-transitory storage medium of claim 13, further comprising communicating the pruned candidate model to the central node along with a loss value based on a local dataset of the source node.

16. The non-transitory storage medium of claim 11, further comprising storing the pruned candidate models and their loss values in the assessment structure and adding loss values determined by the generalization nodes to the loss values in the assessment structure.

17. The non-transitory storage medium of claim 11, further comprising determining an aggregated loss for each of the test candidates identified in the assessment structure.

18. The non-transitory storage medium of claim 17, further comprising eliminating test candidates whose aggregated loss is greater than a threshold loss.

19. The non-transitory storage medium of claim 17, further comprising determining the winning candidate as the test candidate with a lowest aggregated loss, wherein the pruned candidate models are generated in a parallel manner at multiple source nodes and wherein the test candidates are tested in a parallel manner at multiple generalization nodes.

20. A method comprising:
receiving model parameters and a learning rate at a source node from a central node;
sampling the model parameters to obtain an initial model;
training the initial model with a distilled dataset to generate a candidate model;
pruning the candidate model to generate a pruned candidate model;
evaluating a loss of the pruned candidate model against losses of other pruned candidate models generated at the source node;
discarding the pruned candidate models whose loss is greater than a threshold; and
transmitting at least one of the pruned candidate models whose loss is less than or equal to the threshold to the central node.
